(19) United States
(12) Patent Application Publication
(10) Pub. No.: US 2001/0047608 A1
(43) Pub. Date: Dec. 6, 2001

(54) Fishing lure with dual wing compound angle spinning blade

(76) Inventor: Daniel S. Cox, Salt Lake City, UT (US)

Correspondence Address: Daniel McCarthy, McCarthy & Sadler, LC, 39 Exchange Place #100, Salt Lake City, UT, 84111, US

(21) Appl. No.: 09/779,797

(22) Filed: Feb. 6, 2001

Related U.S. Application Data
(60) Provisional application No. 60/118,120, filed on Feb. 1, 1999.

(51) Int. Cl. A01K 85/00

(52) U.S. Cl. 43/42.19

(57) ABSTRACT

A fishing lure with spinning blade is disclosed. The fishing lure has a dual wing compound angle spinning blade with outwardly extending angled turbines which catch water very easily and cause the spinning blade to spin at very slow speeds and when only moved slightly in water so that the lure will provide moving action along river and lake bottoms, in difficult to reach locations, and while jigging.

### CLAIM FOR PRIORITY

Priority is hereby claimed to U.S. Provisional Patent Application Serial No. 60/1181,120 filed on Feb. 8, 2000.

### I. BACKGROUND OF THE INVENTION

A. Field of the Inventions

The invention relates to the field artificial fishing lures for sport fishing. More specifically, the invention relates to fishing lures called ‘spinners’ used for casting or trolling, and some instances for jigging.

B. Prior Art

Recreational fishing or angling is a multi-billion dollar industry that include millions of participants worldwide. It is enjoyed by young and old, novice and expert, and is a particularly wholesome recreational activity for children.

The sale of fishing lures to anglers generates a substantial portion of this annual revenue. Fishing lures are designed to attract fish, but are also sometimes designed with the attraction to anglers.

Fishing lures are made with a great variety of materials, colors and shapes. The prior art contains fishing lures with feathers, spinners, painted bodies, shiny metal objects, noisemakers, vibrators, streamers and a multitude of other structures.

In the prior art, spinners and spoons were commonly known. However, typically the spinning blade of prior art spinners would not begin to spin until the spinner had been pulled through the water at moderate to high velocity for up to a couple of feet. Consequently, prior art spinners were not useful for fishing isolated area or “holes” along rivers or at the edges of ponds or lakes, nor were they useful for jigging.

In U.S. Pat. No. 751,365 issued on Feb. 2, 1904, there is disclosed a with a flat body and a spinner. This type of spinner requires substantial forward velocity and time in order to begin spinning, hence limiting its usefulness.

In U.S. Pat. No. 779,744 issued on Jan. 10, 1905, there is a fishing lure disclosed having a casing and an arcuate spinning blade. This lure has the same problems as that of the '365 patent.

In U.S. Pat. No. 849,743 issued on Apr. 9, 1907, there is a fishing lure disclosed that has an angled body which also serves as a spinner. This arrangement lacks any body or central weight to provide the lure with stability and is therefore unstable, erratic and not useful.

In U.S. Pat. No. 1,495,927 issued on May 27, 1924 there is a fishing lure disclosed having a flat body with an arcute spinner, having the problems previously mentioned above.

In U.S. Pat. No. 1,516,707 issued on Nov. 25, 1924, there is a fishing lure disclosed having a propeller spinner but no separate body. Such a structure will suffer from stability problems and the need for substantial speed and distance in order to commence spinning.

In U.S. Pat. No. 1,772,250 issued on Aug. 5, 1930, there is a fishing lure disclosed having a body with a propeller-type spinner trailing behind it. The body of the lure will tend to create water turbulence which will interfere with proper startup and spinning of the spinning blade.

In U.S. Pat. No. 2,066,815 issued on Jan. 5, 1937, there is disclosed a fishing lure with an arcuate dual wing spinner.

In U.S. Pat. No. 2,586,141 issued on Feb. 19, 1952, there is disclosed a fishing lure with a dual wing spinning blade, having problems as previously mentioned.

In U.S. Pat. No. 3,406,478 issued on Oct. 22, 1968 there is disclosed a fishing lure having a fish-shaped body preceded by a complex reverse mounted spinner.

In U.S. Pat. No. 5,412,900 issued on May 9, 1995 there is disclosed a fishing lure having a complex reverse mounted spinner.

Each of the foregoing references is incorporated herein in its entirety.

In the prior art, there remains a need in the prior art for a fishing lure with a spinning blade whose structure causes the spinning blade to start spinning immediately upon moving through water, even when the lure is moved through water only very slowly.

### II. SUMMARY OF THE INVENTION

It is an object of some embodiments of the invention to provide a fishing lure with a dual wing compound angle spinning blade. The spinning blade has substantial left-right symmetry and has compound angles to provide firm traction or a bite in the water at low velocity. This permits the blade to begin spinning immediately after immersion in the water.

It is an object of some embodiments of the invention to provide a fishing lure which may be used at almost any depth. The spinning blade design which will work at any depth facilitates this.

It is an object of some embodiments of the invention to provide a fishing lure that will work at nearly any speed. The spinning blade will turn at nearly any speed, from very slow to very fast.

It is an object of some embodiments of the invention to provide a fishing lure with multiple relection points. The compound angles of the spinning blade provide multiple flat surfaces which will catch and reflect light at different times, providing more reflection and apparent movement than prior art spinners.

It is an object of some embodiments of the invention to provide a fishing lure which can be used to work the bottom of rivers and lakes. When the present invention is used, the spinning blade will begin to spin immediately as the lure is moved through water, rather than after a greater distance as in prior art lures. Consequently, the lure can be used on lake and river bottoms and in difficult to access “holes” along rivers or lake and pond edges.

It is an object of some embodiments of the invention to provide a fishing lure which provide a moving spinning blade as the lure moves through obstacles in a body of water. The invented lure does this.

These and other objects of the inventions will become apparent to persons of ordinary skill in the art upon reading the specification and viewing the appended drawings.

### III. BRIEF DESCRIPTION OF THE DRAWINGS

FIG. 1 depicts a side view of one preferred embodiment of the invention.

FIG. 2 depicts a side view of another preferred embodiment of the invention.

FIG. 3 depicts a top view of a spinning blade of one preferred embodiment of the invention.

FIG. 4 depicts a top view of a spinning blade of one preferred embodiment of the invention before bending.

FIG. 5 depicts a side view of an alternative embodiment of the invention.

### IV. DETAILED DESCRIPTION OF SOME PREFERRED EMBODIMENTS

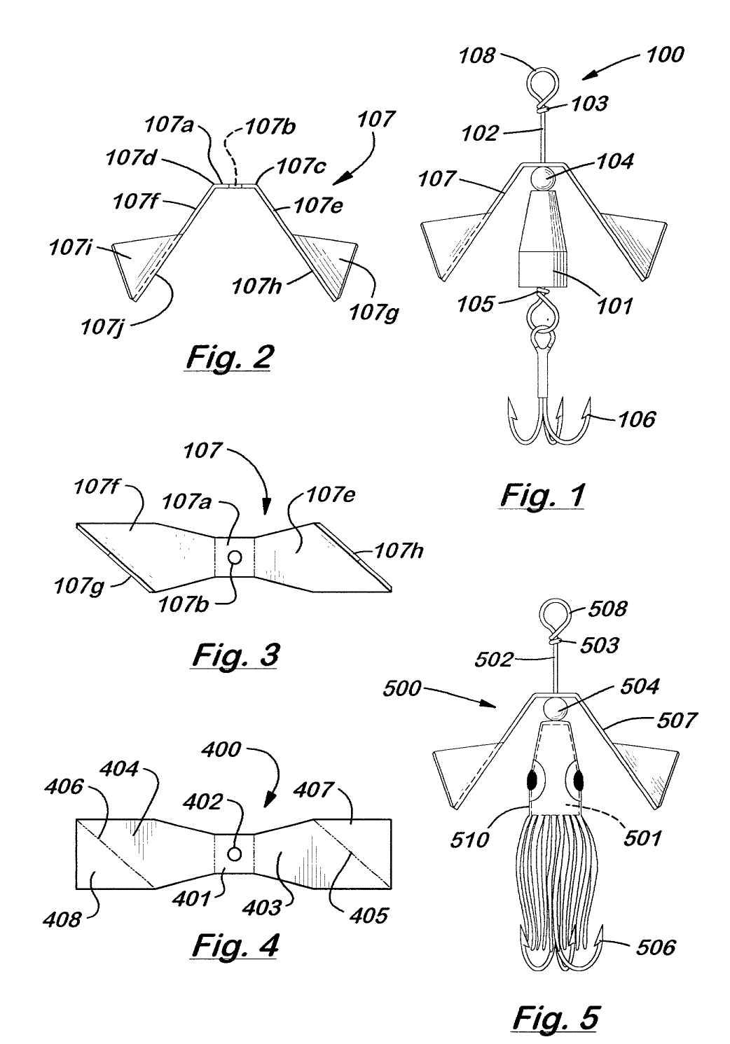

The essence of this invention related to improved blade spin and lure presentation. Referring to FIG. 1, a side view of one preferred embodiment of the invention is shown. The lure 100 has a longitudinal axis along which a stiff wire or post 102 runs, forming a loop or eye 108 at the top and another at the bottom. Knots 103 and 105 secure the loops. The top loop permits attachment of the lure to a fishing line or swivel and the bottom loop permits attachment of a hook 106 such as a treble hook to the lure. The lure 100 includes a turbine blade or double wing spinner 107 following the top eye 107. Below the blade 107, a generally round bead 104 and a body or weight 101 are provided. Each of the blade 107, bead 104 and body 101 have an aperture through which he wire projects. The blade 107 spins about the longitudinal axis of the wire while in use.

Referring to FIGS. 2 and 3 a side view and a top view of blade of the invention is depicted. The blade 107 includes a generally planar center section 107a having an aperture 107b therein for rotation about the longitudinal axis of a fishing lure. The blade 107 has a first angle 107c to form a first wing or blade 107e and a second angle 107d or bend to form a second wing 107f. Both wings 107e and 107f are generally planar and are formed at an obtuse angle with respect to center section 107a. Considering the position of the blade installed on the lure, the wings extend generally downwardly. Each wing has an outwardly extending turbine blade section 107g arid 107i extending from it along bends or angles 107h and 107j. The outwardly extending turbine blade sections are generally planar and are preferably oriented at about a 90 degree angle to the plane of the wing. However, the outwardly extending turbine blades may be oriented at any desired angle such as from 45 degrees to 135 degrees.

The length of 170e and 107f are preferably chosen to cover the body 101. Wings 107e and 107f serve to channel water to outwardly extending turbine blade sections 107g and 107i in order to enhance their grip on water and spinnability. Left to right symmetry of the blade 107 is maintained to achieve balance when the lure moves through water.

The spinner 107 has compound angles in its dual wing design to facilitate the quick spin action that is sought in the invention the angles of bends 406 and 407 (below) should be identical to achieve a balanced spin. The angle at 107c and 107d is preferably about 145 degrees from the plane of the center section 107a. This angle is chosen to keep the wings 107e and 107f close to the body 101 without touching it.

Referring to FIG. 4, a top view of a spinning blade of one preferred embodiment of the invention before bending is shown. It includes a generally flat or planar piece of sheet metal 400 having a center section 401 in which is located an aperture 402 for spinning. The center section 401 is square shaped. From the center section 401, the sheet metal expands in width to each side as it forms two wings 403 and 404. The wings 403 and 404 may be bent at 405 and 406 to form outwardly extending turbine blade sections 407 and 408.

Referring to FIG. 5, a side view of an alternative embodiment of the invention is depicted. It includes a wire eye 508 secured by a knot 503 and a rigid elongate wire or post 502 oriented along the longitudinal axis of the lure 500. A dual wing spinning blade or turbine 507 is provide atop a round bead and a body or weight 501. A hook 506 is provided for securing a fish. A plastic or rubber cover 510 for the body is provided to give the lure a squid-like appearance to attract different types of fish.

As shown above, the lure has left-right symmetry along its longitudinal axis. The angles of the bends in the turbine are chosen to cause the turbine to closely conform to the lure body and to easily grab water and spin when the lure is moved even a slight amount. Some prior art spinners protrude too far from the lure and can actually interfere with a fish biting the lure. The length of the turbine blade was chosen so that after bending, it would cover at least 80% of the lure body. By covering the body to such an extent, the turbine blade creates the appearance of movement over most of the lure and improves its attractiveness to fish. Prior art blades places at the front or back of a lure did not achieve this.

In contrast with prior art lures which require high speed or jerking of the fishing pole to start their blade spinning, the outwardly extending turbine sections grab or bite into water very easily, so even slight movement of the lure in water causes the blade to spin. Even jigging the lure vertically will cause spin. This allows the lure to be dropped into any attractive fish hiding location and begin fishing, while prior art lures could not get into action in time to attract fish from their hiding places. Further, the outwardly extending turbine sections also tend to have the appearance of fish fins, further enhancing the attractiveness of the lure. The effectiveness of the turbines in gripping water also lets the lure be operated at very slow speeds, as may be necessary for fishing near the bottom of a river or lake. And when the lure strikes and obstacle such as a rock or log, the turbine blade will immediately stabilize the lure and keep it swimming properly so that it is always working to attract fish. This is critical because if a spinner stops spinning even momentarily, fish will lose interest and move away.

It can also be seen that the several bends on the turbine blade will reflect light at different angles, providing more action in the lure and greater attractiveness to fish. And the lure has proven to work well in calm water as well as in water with currents in various directions, in contrast to many prior art lures.

While the present inventions have been described and illustrated in conjunction with a number of specific embodiments, those skilled in the art will appreciate that variations and modifications may be made without departing from the principles of the inventions as herein illustrated, described and claimed.

The present inventions may be embodied in other specific forms without departing from their spirit or characteristics. The described embodiments are to be considered in all respects as only illustrative, and not restrictive. The scope of the inventions are, therefore, indicated by the appended claims, rather than the foregoing description. All changes which come within the meaning and range of equivalency of the claims are to be embraced within their scope.

I claims:

1. A fishing lure comprising:
a generally straight and rigid wire with a longitudinal axis, a first end and a second end,
an eye located at said rigid wire first end,
a dual wing compound angle spinning blade located adjacent said eye, said spinning blade having an aperture therein through which said rigid wire projects, said spinning blade having generally right to left symmetry with respect to said aperture, said spinning blade being formed and adapted for continuous rotational motion about said longitudinal axis of said rigid wire,
a generally planar center section on said dual wing compound angle spinning blade, said center section being generally rectangular in shape and having said aperture centrally located thereon,
first and second wing sections emanating from said center section, said first and second wings having a greater width and length than said center section, said first and second wings departing said center section at an obtuse angle from the plane of said center section, said first and second wing sections being generally planar in shape,
first and second outwardly extending turbine blade sections angularly extending from said first and second wing sections respectively, said first and second outwardly extending turbine blade sections being formed and adapted to catch water and cause said spinning blade to rotate about said longitudinal axis, said first and second wing sections serving to cause water to flow along their surfaces to said first and second outwardly extending turbine blade sections,
a round bead located on said rigid wire between said spinning blade and said hook, said round bead having an aperture therein to permit said rigid wire to project therethrough, and said round bead being movable along said rigid wire longitudinal axis,
a body located on said rigid wire between said round bead and said hook, said body having a mass chosen to serve as a weight for the fishing lure in order to keep it submerged in water while in use, said body having an aperture therein to permit said rigid wire to project therethrough, and said body being movable along said rigid wire longitudinal axis, and
a hook located at said rigid wire second end.

2. A lure as recited in claim 1 further comprising a covering on said body.

3. A lure as recited in claim 2 wherein said covering resembles a squid.

4. A lure as recited in claim 1 wherein said spinning blade has surfaces which reflect light.

5. A lure as recited in claim 1 wherein said spinning blade serves to substantially cover and obscure said body when the lure is in use in water.

6. A lure as recited in claim 1 wherein said first and second wing sections are oriented at an angle in the range of about 145 degrees with respect to said center section.

7. A lure as recited in claim 1 wherein said first and second outwardly extending turbine blade sections are oriented at an angle of about 45 to 135 degrees with respect to said first and second wing sections respectively.

8. A lure as recited in claim 1 wherein said first and second outwardly extending turbine blade sections are oriented at an angle of about 90 degrees with respect to said first and second wing sections respectively.

9. A fishing lure comprising:
a generally straight and rigid wire with a longitudinal axis, a first end and a second end,
a dual wing compound angle spinning blade located adjacent said eye, said spinning blade having an aperture therein through which said rigid wire projects, said spinning blade having generally right to left symmetry with respect to said aperture, said spinning blade being formed and adapted for continuous rotational motion about said longitudinal axis of said rigid wire,
a generally planar center section on said dual wing compound angle spinning blade,
first and second wing sections emanating from said center section, said first and second wings departing said center section at an obtuse angle from the plane of said center section, said first and second wing sections being generally planar in shape,
first and second outwardly extending turbine blade sections angularly extending from said first and second wing sections respectively, said first and second outwardly extending turbine blade sections being formed and adapted to catch water and cause said spinning blade to rotate about said longitudinal axis, said first and second wing sections serving to cause water to flow along their surfaces to said first and second outwardly extending turbine blade sections,
a body located on said rigid wire between said round bead and said hook, said body having a mass chosen to serve as a weight for the fishing lure in order to keep it submerged in water while in use, said body having an aperture therein to permit said rigid wire to project therethrough, and said body being movable along said rigid wire longitudinal axis, and
a hook located at said rigid wire second end.

10. A lure as recited in claim 9 wherein said spinning blade is sized to substantially obscure said body when the lure is in use in water.

11. A lure as recited in claim 9 further comprising a covering on said body.

10. A lure as recited in claim 10 wherein said covering resembles a squid.

11. A lure as recited in claim 9 wherein said spinning blade has surfaces which reflect light.

12. A lure as recited in claim 9 wherein said spinning blade serves to substantially cover and obscure said body when the lure is in use in water.

13. A lure as recited in claim 9 wherein said first and second wing sections are oriented at an angle in the range of about 145 degrees with respect to said center section.

14. A lure as recited in claim 9 wherein said first and second outwardly extending turbine blade sections are oriented at an angle of about 45 to 135 degrees with respect to said first and second wing sections respectively.

15. A lure as recited in claim 9 wherein said first and second outwardly extending turbine blade sections are oriented at an angle of about 90 degrees with respect to said first and second wing sections respectively.
